(19) United States
(12) Patent Application Publication
(10) Pub. No.: US 2008/0140306 A1
(43) Pub. Date: Jun. 12, 2008

(54) Voice recognition method and system for displaying charts and maps

(76) Inventors: Ken L. Snodgrass, Peoria, AZ (US); Mark L. Goldberg, Peoria, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/291,796

(22) Filed: Nov. 30, 2005

(51) Int. Cl. G01C 21/00

(52) U.S. Cl. 701/200

(57) ABSTRACT

An aircraft information retrieval system comprises a digital audio panel operable to receive an analog voice signal representing a request for the display of graphical information and convert the analog voice signal to a digital voice signal. The system further comprises a remote audio processor coupled to the digital audio panel, the remote audio processor configured to receive the digital voice signal. The remote audio processor is further operable to determine an information request from the digital voice signal. A command processor, coupled to the remote audio processor, is configured to receive the information request and to retrieve the graphical information.

### TECHNICAL FIELD OF THE INVENTION

This invention relates to the field of avionic controls and more specifically, to a voice recognition method and system for displaying charts and maps.

### BACKGROUND OF THE INVENTION

Pilots use maps and charts to help them navigate during flight. These maps and charts show the features of the airspace through which the pilot flies. For example, certain maps and charts are used for visual flying. These maps provide details about the terrain features such as rivers, lakes and the like, which the pilot can use to assist in navigation. Additionally, certain maps and charts are used for flying under instrument flight rules. Multiple maps and charts are needed when the aircraft is flying further than the coverage of a single map or chart. Therefore, the collection of maps and charts used for navigation can be extensive. Additionally, the pilot may need to search for the correct map or chart and then determine the aircraft's position relative to the map or chart. All of this activity can distract the pilot from other flying duties.

To help alleviate this problem, digital maps and charts have been developed. Digital maps and charts can be stored in a database and retrieved by the pilot when needed. The digital maps and charts can be displayed on a display unit in the aircraft. The use of digital maps and charts eliminates the need to carry a collection of heavy and bulky paper maps. However, the pilot may still rely on an interface in the cockpit to recall specific maps and charts. The pilot may also use an interface to enter commands to zoom in and out of a map, pan across a map, select or recall different maps. This results in the pilot spending time locating and manipulating digital maps that may distract from other flying duties.

In view of the foregoing, it is desirable to provide a system and method for displaying and controlling charts and maps that addresses one or more of the foregoing deficiencies or other deficiencies not implicitly or expressly described. Furthermore, other desirable factors and characteristics of the present invention will become apparent from the subsequent detailed description and the appended claims, taken in conjunction with the accompanying drawings and the foregoing technical field and background.

### SUMMARY OF THE INVENTION

A method for requesting information for viewing on a display comprises a first step of receiving a voice recognition pattern. Next, a digitized speech request to display information is received. The digitized speech is converted to an interpreted command using the voice recognition pattern and the information is retrieved from a database using the interpreted command.

An aircraft information retrieval system comprises an audio panel operable to receive an analog voice signal representing a request for the display of graphical information and convert the analog voice signal to a digital voice signal. The system further comprises an audio processor coupled to the audio panel, the audio processor configured to receive the digital voice signal. The audio processor is further operable to determine an information request from the digital voice signal and retrieve the graphical information.

In another embodiment, a device for recognizing a request for display of a navigational map for an airplane comprises a database containing the navigational map. The device also comprises a remote audio processor configured to receive a digital voice request for display of the navigational map, to recognize the digital voice request as a request to retrieve the navigational map, and to retrieve the navigational map from the database

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures:

FIG. 1 is a block diagram of an exemplary voice recognition system in accordance with an exemplary embodiment of the present invention; and

FIG. 2 is a flowchart illustrating an exemplary method for displaying maps on a display screen in accordance with an exemplary embodiment of the present invention.

### DETAILED DESCRIPTION OF THE DRAWINGS

The following detailed description is merely illustrative in nature and is not intended to limit the invention or the application and uses of the invention. Furthermore, there is no intention to be bound by any expressed or implied theory presented in the preceding technical field, background, brief summary or the following detailed description. While the following exemplary embodiment discusses the retrieval of maps and charts, the present invention can be used to retrieve any displayable information. The terms map and chart can be used interchangeably to mean displayable graphical information. Additionally, maps and charts can be referred to as graphical navigational information.

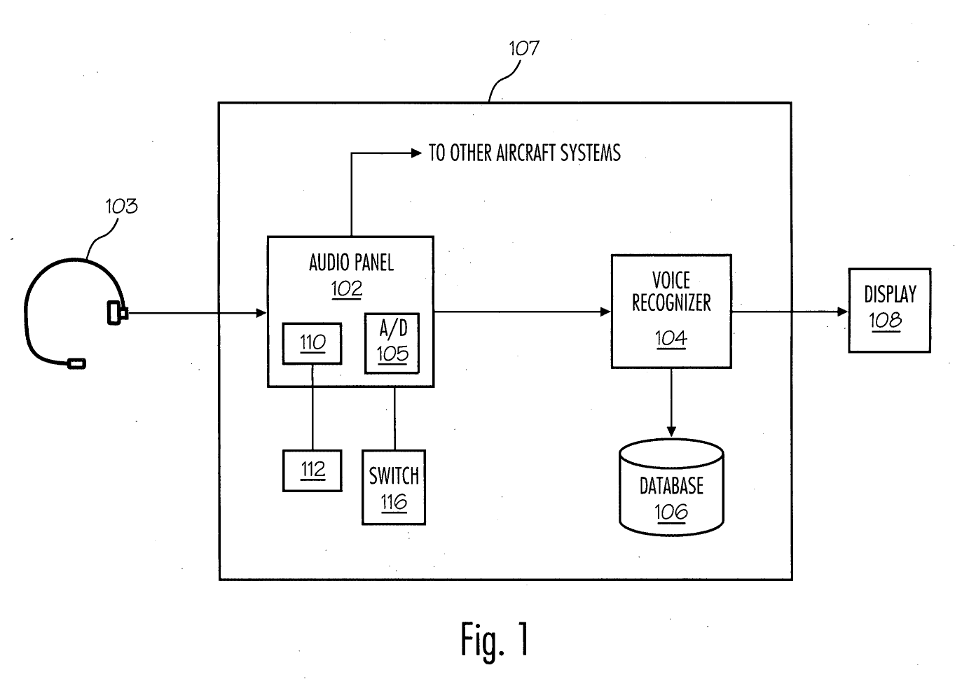

An exemplary voice activated map display system 100 is illustrated in FIG. 1. Map display system 100, in one exemplary embodiment of the present invention, is configured to receive analog voice commands concerning map and chart display, convert the analog voice commands to a digital voice command and, using voice recognition software, interpret the digital voice command to a command that can be used to retrieve or manipulate maps and charts. System 100 includes an audio processor 107, comprising an audio panel 102 coupled to a voice recognizer 104 and a database 106. System 100 also includes a display 108.

Audio panel 102 can be any device that can be used to provide speech signals to aircraft systems. The audio panel 102, in one exemplary embodiment, receives analog speech from, for example, a user speaking into headset 103 or similar device and converts the analog speech signal into digital speech signals using an analog to digital converter 105. In one exemplary embodiment, the audio panel 102 digitizes analog speech to allow the digital speech signals to be routed to various communication systems (not pictured). In an alternative embodiment, analog speech from a user can be digitized before presentation to the audio panel. For example, the headset 103 may digitize the user's speech. Thus, in this embodiment, the audio panel 102 can accept digitized signals. The speech input in this case would bypass the analog-to-digital converter 105.

Voice recognizer 104 receives digitized speech from, in an exemplary embodiment, audio panel 102, performs voice recognition of the digitized speech, and provides for the display and manipulation of maps and charts. Voice recognizer 104 is configured to execute voice recognition software to convert the vocalized instructions spoken by the pilots to interpreted commands useable to retrieve, in one exemplary embodiment, maps and charts from the database 106. While voice recognizer 104 is illustrated in FIG. 1 as a separate entity coupled to the audio panel 102, voice recognition can occur at any part of the system. For example, voice recognition can occur at the display 108 or the audio panel 102. Additionally, the functionality of the audio panel 102 and the voice recognizer 104 can be combined together as the audio processor 107.

Because voice patterns differ among people, and because it is possible that different pilots could use the same aircraft, the voice recognition program by itself may have trouble in translating the digitized commands. For example, an airline could have pilots with different accents that fly the same aircraft at different times. The difference in the voice patterns of the pilots could be such that voice recognition would be difficult. To alleviate this potential problem and to increase the overall accuracy of the voice recognition software, the voice pattern of all potential users of an aircraft is preferably obtained and stored for use with the voice recognition software.

In one exemplary embodiment, the voice patterns of a user are obtained for use with the voice recognition software. In this exemplary embodiment, the audio panel 102 can include a memory device input 110 configured to receive a memory device 112 that stores the voice pattern of a pilot. The memory device 112 can be inserted into the memory device input 110 of the audio panel 102 and so that the stored voice pattern is provided to the voice recognition software executed, in one exemplary embodiment at the voice recognizer 104. In one exemplary embodiment, each user of the present invention prerecords their voice patterns onto memory devices 112 for use with the voice recognition software and inserts the memory device 112 into the memory device input 110 of an aircraft before flying the aircraft. In an alternative embodiment, all members of a flight crew can have their voice patterns placed on a single memory device 112, simplifying the downloading of voice patterns.

In one exemplary embodiment, the memory device input 110 is located on the audio panel 102, although any suitable location can be used. The memory devices 112 can be any memory such as a compact flash card, a smart media card, and the like. A voice pattern can be any information or data for use with voice recognition software. If an aircraft does not have a large number of different pilots, the voice pattern of all potential pilots can be recorded and stored in the aircraft with the voice recognition software and memory device 112 would not be needed.

A switch 116 can be optionally provided to allow a user to select a communication path. For example, in one exemplary embodiment, switch 116 can be in a first position, which sends the digitized voice from the audio panel 102 to the voice recognizer 104 for voice recognition, and, in a second position, which sends the digitized voice to other airplane systems, such as a UHF radio. In one exemplary embodiment, the switch 116 is located on the audio panel 102, although other suitable locations for switch 116 can be used. Switch 116, in one exemplary embodiment, is held down while the user speaks map and chart commands into the headset 103.

Once a proper map or chart is retrieved, the user of the system 100 can then manipulate the map using voice commands that can be converted into interpreted commands by the voice recognition program. Voice commands can be used to replace any map or chart operation a pilot can do manually. For example, the user might request that the map image be zoomed in or out in order to see more or less detail about an area. Additionally, the user may request that the map image be panned left, right, up and down to locate a specific area on the map.

The design of the system 100, as discussed above, is an exemplary embodiment of a system to convert analog speech to a computer usable form to retrieve and display maps and charts. The functionality of the individual components in FIG. 1 can be combined or spread out among the same or additional components. For example the audio panel 102 and the voice recognizer 104 can be provided as a single processor to access the database 106. Some or all of the functionality of the audio processors 107 can be placed in any convenient location on the aircraft, including being integrated with the display 108.

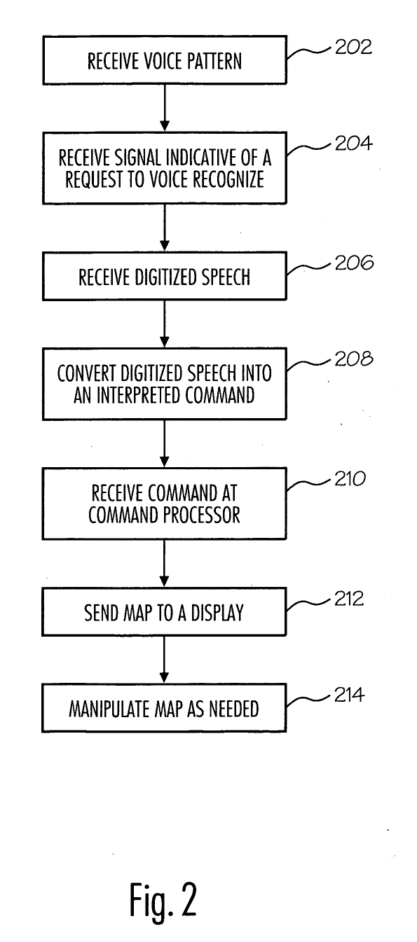

A flowchart, as shown in FIG. 2, provides an exemplary method for displaying and manipulating maps and charts for an aircraft. In a first step, step 202, the voice recognizer 104 receives a voice pattern for a particular user. As discussed previously, the voice pattern can be stored on memory devices 112 and provided to the voice recognizer 104 for use in voice recognition by inserting the memory device 112 into the memory input device 110 and transferring the voice pattern for use with the voice recognition software. Alternatively, the voice pattern for one or more pilots can be stored on the system 100 and retrieved for use by the voice recognition program when needed.

Next, in optional step 204, a signal indicative of a request to voice recognize digitized speech is received, in one exemplary embodiment, at the voice recognizer 104. In one exemplary embodiment, the signal is produced by switch 116, although the signal can be generated in several different ways.

Next, in step 206, digitized speech is received, in one exemplary embodiment, at the voice recognizer 104. The digitized speech represents a spoken request for, in an exemplary embodiment, the display of a chart or a map.

In step 208, a speech recognition program, along with the voice pattern received in step 202, converts the digitized speech into an interpreted command for retrieval or manipulation of a map or a chart. In one exemplary embodiment, this can be done at the voice recognizer 104. In the event the digitized speech can not be converted into an interpreted command, the user would receive feedback indicating failure in recognizing the user's voice command.

In step 210, the commands generated in step 208 can be executed. The command can be a command to retrieve a chart or map, which results in the requested map or chart being retrieved from the map database 106. Additionally, the command can be a command to manipulate a displayed image which causes the manipulation of the displayed image on the display 108.

After retrieving the requested map or chart, the map image can be sent to a display 108 for use by the pilot or other flight crew member, in step 212. In step 214, the map can be manipulated via voice commands in order to allow the user to zoom in and out, pan left, right, up and down, page through multi-page maps and charts, and perform any other map or chart related function.

The exemplary embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

1. A method for requesting graphical navigational information for viewing on a display comprising:
receiving a voice recognition pattern;
receiving a digitized speech request to display the graphical navigational information;
converting the digitized speech request to an interpreted command using the voice recognition pattern; and
retrieving the graphical navigational information from a database using the interpreted command.

2. The method of claim 1 further comprising the step of displaying the graphical navigational information on a display.

3. The method of claim 2 further comprising the step of manipulating the displayed information in response to a user's command.

4. The method of claim 1 wherein the step of receiving a voice recognition pattern further comprises retrieving the voice recognition pattern stored on a memory card.

5. The method of claim 1 further comprising receiving an indication that the digitized speech request is related to graphical navigational data.

6. The method of claim 1 wherein the step of receiving a voice recognition pattern further comprises retrieving a locally stored voice recognition pattern.

7. The method of claim 1 wherein the step of receiving a digitized speech request further comprises:
receiving an analog speech request;
converting the analog speech request to a digitized speech request; and
receiving the digitized speech request at an audio processor.

8. An aircraft information retrieval system comprising:
removable memory means adapted to store voice patterns;
audio processing means for receiving a voice signal representing a request for the display of graphical navigational information; the audio processing means further configured for determining an information request from the voice signal and adapted to at least selectively couple with the removable memory means and retrieve a voice pattern stored on the removable memory means; and
display means for displaying the graphical navigational information.

9. The system of claim 8 wherein the audio processing means utilizes voice recognition software to interpret the voice signal.

10. The system of claim 9 wherein the voice recognition software uses a voice pattern of a user to assist in interpreting the voice signal.

11. The system of claim 10 wherein the audio processing means uses a voice pattern from the removable memory means.

12. The system of claim 10 wherein at least one voice pattern is provided with the voice recognition software.

13. The system of claim 8 further comprising a map database coupled to the audio processing means, the map database comprising a plurality of maps.

14. The system of claim 8 further comprising a switch coupled to the audio processing means, the switch is configured to allow the determination of the information request.

15. The system of claim 14 wherein the switch, when deactivated, allows voice signals to be sent to other aircraft components.

16. The system of claim 8 further comprising a headset coupled to the audio processing means, the headset outputting an analog voice signal to the audio processing means.

17. The system of claim 16 wherein the headset outputs a digitized voice signal to the audio processing means.

18. A device for recognizing requests for display of graphical navigational information for an airplane the device comprising:
a database containing the graphical navigational information;
a voice recognizer coupled to the database and configured to receive a digital voice request for display of the graphical navigational information, to recognize the digital voice request as a request to retrieve the graphical navigational information, and to retrieve the graphical navigational information from the database.

19. The device of claim 18 wherein a voice recognition program executing on the voice recognizer converts the digital voice request to the request to retrieve the graphical navigational information.

20. The device of claim 19 wherein the voice recognition uses a prerecorded voice pattern of a pilot to convert assist in converting the digital voice request to the request to retrieve the graphical navigational information.
